(19) United States
(12) Patent Application Publication
(10) Pub. No.: US 2015/0288749 A1
(43) Pub. Date: Oct. 8, 2015

(54) COMMUNICATION SYSTEM, ELECTRONIC BOOK TERMINAL, COMMUNICATION METHOD, PROGRAM, AND RECORDING MEDIUM

(71) Applicant: RAKUTEN, INC., Shinagawa-ku, Tokyo (JP)

(72) Inventors: Kenji Sugiura, Shinagawa-ku (JP); Reina Otsuka, Shinagawa-ku (JP); Mutsumi Fukuda, Shinagawa-ku (JP)

(73) Assignee: Rakuten, Inc., Shinagawa-ku, Tokyo (JP)

(21) Appl. No.: 14/435,623

(22) PCT Filed: Dec. 27, 2012
(86) PCT No.: PCT/JP2012/083960

§ 371 Date: Apr. 14, 2015

(51) Int. Cl. H04L 29/08; G06F 3/0484

(52) U.S. Cl. CPC H04L 67/10; G06F 3/04842

(57) ABSTRACT

A first-portion acquirer receives a designation of a first portion included in an electronic book from a user. A first-notification transmitter transmits, to another electronic book terminal on which the electronic book is viewable, a first notification that designates the first portion. A second-notification receiver receives a second notification from the other electronic book terminal, when the other electronic book terminal that has received the first notification allows another user to view the first portion designated by the received first notification and transmits the second notification that designates a second portion that is included in the electronic book and is designated by the other user. A display controller allows the user to view the second portion designated by the received second notification. An operation controller ignores, after the first notification is transmitted and until the second notification is received, any operation attempted by the user for viewing the electronic book.

### TECHNICAL FIELD

The present disclosure relates to a communication system between a plurality of electronic book terminals on which an identical electronic book is viewable, an electronic book terminal, a communication method, a program, and a recording medium.

### BACKGROUND ART

Conventionally, communication systems that enable mutual communication among users who are utilizing an identical book consisting of digital characters and/or images (hereinafter referred to as “electronic book”) via electronic-book-view-capable electronic devices have been known. For example, Patent Literature 1 discloses a communication system among a plurality of electronic devices containing an identical electronic book, the communication system enabling one electronic device to transmit results of electronic-data editing work conducted on the one electronic device to other electronic devices so that the plurality of electronic devices can share the results of the editing work.

### CITATION LIST

### Patent Literature

Patent Literature 1: Unexamined Japanese Patent Application Kokai Publication No. 2012-108675

### SUMMARY OF INVENTION

### Technical Problem

Unfortunately, in such a communication system as described in Patent Literature 1, a user may send unsolicited information to other users, thereby obstructing moderated communication among the users.

The present disclosure has been made in consideration of the above-described circumstances, and it is an objective of the present disclosure to provide a communication system, an electronic book terminal, a communication method, a program, and a recording medium that can facilitate moderated communication between users who can view an identical electronic book.

### SOLUTION TO PROBLEM

To achieve the foregoing objective, a communication system according to the present disclosure comprises a first electronic book terminal and a second electronic book terminal, the first electronic book terminal enabling a first user to view an electronic book based on an operation by the first user, the second electronic book terminal enabling a second user to view the electronic book based on an operation by the second user, wherein
(a) the first electronic book terminal receives a designation of a first portion included in the electronic book from the first user, and transmits, to the second electronic book terminal, a first notification that designates the received first portion,
(b) the second electronic book terminal receives the first notification transmitted from the first electronic book terminal, allows the second user to view the first portion designated by the received first notification, receives a designation of a second portion included in the electronic book from the second user, and transmits, to the first electronic book terminal, a second notification that designates the second portion,
(c) the first electronic book terminal receives the second notification transmitted from the second electronic book terminal, and allows the first user to view the second portion designated by the received second notification, and
(d) the first electronic book terminal ignores, after transmitting the first notification and until receiving the second notification, any operation attempted by the first user for viewing the electronic book.

In the communication system according to the above-described aspect, if the second notification has not been received by the end of a predetermined time period after the transmission of the first notification, the first electronic book terminal permits the operation attempted by the first user for viewing the electronic book, in exchange for a predetermined compensation from the first user.

In the communication system according to the above-described aspect, the first electronic book terminal transmits the first notification to a plurality of second electronic book terminals, and permits, if the number of the received second notifications meets a predetermined condition, the operation attempted by the first user for viewing the electronic book.

In the communication system according to the above-described aspect, the second electronic book terminal stores a history of the received first notification in a first-notification history storage,
when receiving the first notification transmitted from the first electronic book terminal, the second electronic book terminal acquires a history of a past first notification from the first-notification history storage, the past first notification being transmitted in the past by the first electronic book terminal that has transmitted the received first notification, and
the second electronic book terminal allows the second user to view the first portion designated by the received first notification and the acquired history of the past first notification.

In the communication system according to the above-described aspect, if the first portion designated by the received first notification is a portion that has yet to be read by the second user, the second electronic book terminal ignores a fact that the first notification has been received.

An electronic book terminal according to a second aspect of the present disclosure enables a user to view an electronic book based on an operation by the user, the electronic book terminal comprising:
a first-portion acquirer that receives a designation of a first portion included in the electronic book from the user;
a first-notification transmitter that transmits a first notification to another electronic book terminal on which the electronic book is viewable, the first notification designating the received first portion;
a second-notification receiver that receives a second notification transmitted from the other electronic book terminal, when the other electronic book terminal receives the first notification, allows another user to view the first portion designated by the received first notification, receives a designation of a second portion included in the electronic book from the other user, and transmits the second notification that designates the second portion;
a display controller that allows the first user to view the second portion designated by the received second notification; and
an operation controller that ignores, after the first notification is transmitted and until the second notification is received, any operation attempted by the user for viewing the electronic book.

A communication method according to a third aspect of the present disclosure is executed by a first electronic book terminal and a second electronic book terminal,
the first electronic book terminal enabling a first user to view an electronic book based on an operation by the first user, and including a first-portion acquirer, a first-notification transmitter, a second-notification receiver, a second-display controller, and an operation controller,
the second electronic book terminal enabling a second user to view the electronic book based on an operation by the second user, and including a first-notification receiver, a first-display controller, a second-portion acquirer, and a second-notification transmitter,
the communication method comprising:
(a) for the first electronic book terminal,
   a first portion acquiring step in which the first-portion acquirer receives a designation of a first portion included in the electronic book from the first user, and
   a first notification transmitting step in which the first-notification transmitter transmits, to the second electronic book terminal, a first notification that designates the received first portion,
(b) for the second electronic book terminal,
   a first notification receiving step in which the first-notification receiver receives the first notification transmitted from the first electronic book terminal,
   a first-display controlling step in which the second-display controller, the second-portion acquiring step, allows the second user to view the first portion designated by the received first notification,
   a second portion acquiring step in which the second-portion acquirer receives a designation of a second portion included in the electronic book from the second user, and
   a second notification transmitting step in which the second-notification transmitter transmits, to the first electronic book terminal, a second notification that designates the second portion,
(c) for the first electronic book terminal,
   a second notification receiving step in which the second notification receiver receives the second notification transmitted from the second electronic book terminal, and
   a second-display controlling step in which the first-display controller allows the first user to view the second portion designated by the received second notification, and
(d) for the first electronic book terminal,
   an operation controlling step in which the operation controller ignores any operation attempted by the first user for viewing the electronic book after the first notification is transmitted until the second notification is received.

A program according to a fourth aspect of the present disclosure allows a computer that enables a user to view an electronic book based on an operation by the user to function as:
a first-portion acquirer that receives a designation of a first portion included in the electronic book from the user;
a first-notification transmitter that transmits, to another electronic book terminal on which the electronic book is viewable, a first notification that designates the received first portion;
a second-notification receiver that receives a second notification transmitted from the other electronic book terminal, when the other electronic book terminal receives the first notification, allows another user to view the first portion designated by the received first notification, receives a designation of a second portion included in the electronic book from the other user, and transmits the second notification that designates the second portion;
a display controller that allows the user to view the second portion designated by the received second notification; and
an operation controller that ignores, after the first notification is transmitted and until the second notification is received, any operation attempted by the user for viewing the electronic book.

A computer-readable non-transitory recording medium according to a fifth aspect of the present disclosure is a computer-readable non-transitory recording medium on which a program is recorded that allows a computer that enables a user to view an electronic book based on an operation by the user to function as:
a first-portion acquirer that receives a designation of a first portion included in the electronic book from the user;
a first-notification transmitter that transmits, to another electronic book terminal on which the electronic book is viewable, a first notification that designates the received first portion;
a second-notification receiver that receives a second notification transmitted from the other electronic book terminal, when the other electronic book terminal receives the first notification, allows another user to view the first portion designated by the received first notification, receives a designation of a second portion included in the electronic book from the other user, and transmits the second notification that designates the second portion;
a display controller that allows the user to view the second portion designated by the received second notification; and
an operation controller that ignores, after the first notification is transmitted and until the second notification is received, any operation attempted by the user for viewing the electronic book.

### Advantageous Effects of Invention

According to the present disclosure, it is possible to facilitate moderated communication between users who can view an identical electronic book.

### BRIEF DESCRIPTION OF DRAWINGS

FIG. 1 shows a schematic configuration of a communication system according to an embodiment;

FIG. 2 is a schematic block diagram showing a hardware configuration of an electronic book terminal according to the embodiment;

FIG. 3 shows an example of an electronic book displayed on a display;

FIG. 4 is a schematic block diagram showing a functional configuration of a controller of the electronic book terminal according to the embodiment;

FIG. 5 shows an example of a flowchart of a view-sharing process according to the embodiment;

FIG. 6 shows an example of a flowchart of a view-sharing process according to Modification 1;

FIG. 7 shows a schematic configuration of a communication system according to Modification 2;

FIG. 8 shows an example of a flowchart of a view-sharing process according to Modification 2;

FIG. 9 shows an example of a flowchart of a view-sharing process according to Modification 3;

FIG. 10 shows an example of data stored in a first-notification history DB;

FIG. 11 shows an example of a first portion and history data displayed on the display; and

FIG. 12 shows an example of a flowchart of a view-sharing process according to Modification 4.

### DESCRIPTION OF EMBODIMENTS

An embodiment of the present disclosure is now explained in detail with reference to the drawings.

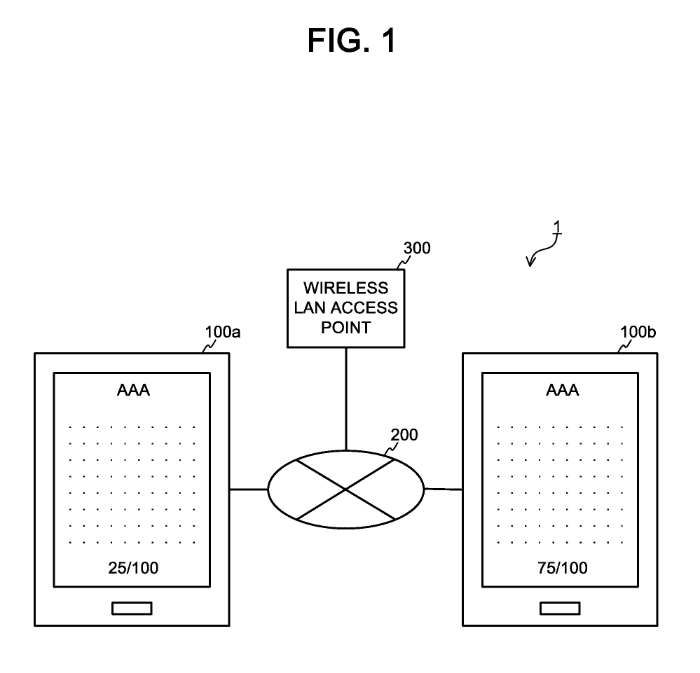

FIG. 1 shows a configuration of a communication system 1 according to an embodiment of the present disclosure. As shown in FIG. 1, the communication system 1 comprises a first electronic book terminal 100a and a second electronic book terminal 100b. The first electronic book terminal 100a and the second electronic book terminal 100b are communicatively connected to each other via a network 200.

More specifically, the network 200 is a local area network (LAN). Moreover, a wireless LAN access point 300 is connected to the network 200. The first electronic book terminal 100a and the second electronic book terminal 100b have functions to connect to the network 200 wirelessly and communicate with each other via the wireless LAN access point 300 that relays the communication therebetween.

The first electronic book terminal 100a is a terminal device that enables a user of the first electronic book terminal 100a (hereinafter referred to as “first user”) to view an electronic book based on an operation by the first user. The second electronic book terminal 100b is a terminal device that enables a user of the second electronic book terminal 100b (hereinafter referred to as “second user”) to view the electronic book based on an operation by the second user. The first electronic book terminal 100a and the second electronic book terminal 100b, which are similar in configurations, are both hereinafter referred to as an electronic book terminal 100.

A hardware configuration of the electronic book terminal 100 is now explained.

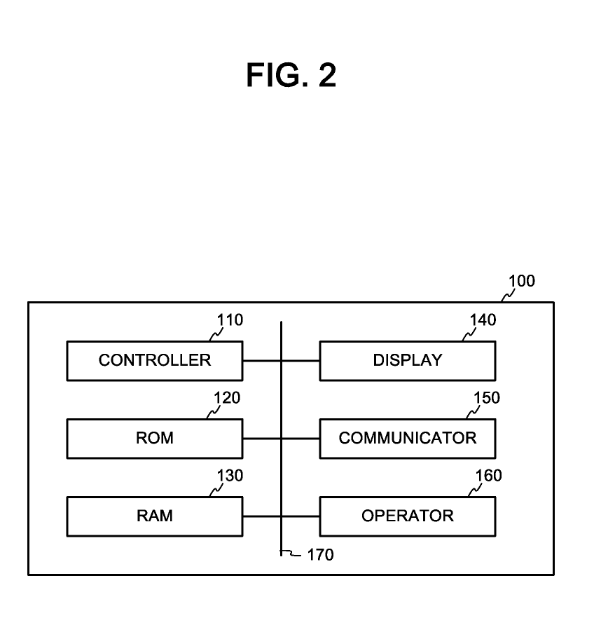

FIG. 2 is a schematic block diagram showing a hardware configuration of the electronic book terminal 100. As shown in FIG. 2, the electronic book terminal 100 includes a controller 110, a read only memory (ROM) 120, a random access memory (RAM) 130, a display 140, a communicator 150, and an operator 160, all of which are connected to one another via a bus 170.

The controller 100 comprises, for example, a central processing unit (CPU) and controls the entire electronic book terminal 100.

The ROM 120 is a non-volatile memory for storing various kinds of data and programs for allowing the controller 110 to control the entire electronic book terminal 100.

Furthermore, an electronic book is stored in the ROM 120. The electronic book stored in the ROM 120 is, for example, data purchased by a user via a website from a seller who sells electronic books and then downloaded from the seller's server.

The RAM 130 is a volatile memory for temporarily storing information generated by the controller 140 and data needed to generate the information.

The display 140 comprises a display device that includes a liquid crystal display (LCD), a backlight, and the like. The display 140 displays, for example, the electronic book stored in the ROM 120, under control of the controller 110.

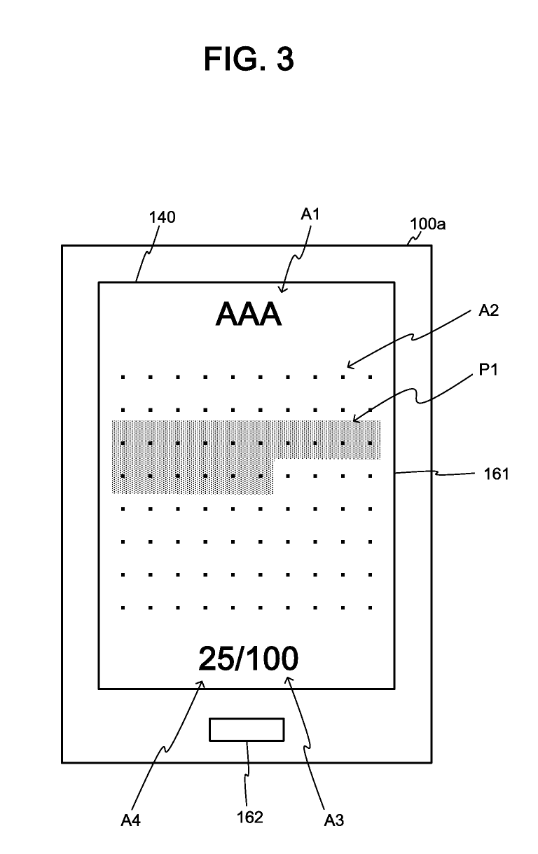

FIG. 3 shows an example of the electronic book displayed on the display 140. As shown in FIG. 3, the display 140 displays data contained in the electronic book, such as a title A1, text A2, the total number of pages A3, and a currently-displayed page number A4.

The communicator 150 comprises a communication interface for connecting the electronic book terminal 100 to the network 200.

The operator 160 comprises an input device such as a button, touch panel, and/or the like. The operator 160 receives an operation input from a user, and outputs an operation-input signal that corresponds to the received operation input, to the controller 110.

More specifically, as shown in FIG. 3, the operator 160 includes, on the upper surface of the display 140, a touch part 161 that is transparent and a button 162. The touch part 161 receives a touch operation input from the user, and outputs an operation-input signal that corresponds to the received touch operation input, to the controller 110.

A functional configuration of the electronic book terminal 100 is now explained.

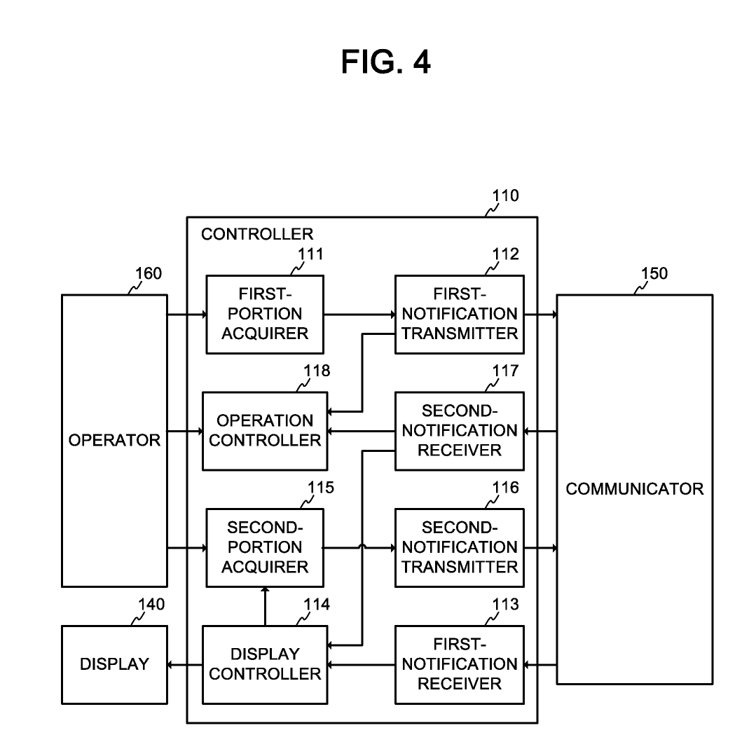

FIG. 4 is a schematic block diagram showing a functional configuration of the controller 110 of the electronic book terminal 100. As shown in FIG. 4, the controller 110 functions as a first-portion acquirer 111, a first-notification transmitter 112, a first-notification receiver 113, a display controller 114, a second-portion acquirer 115, a second-notification transmitter 116, a second-notification receiver 117, and an operation controller 118.

The first-portion acquirer 111 receives a designation of a first portion included in an electronic book from a user.

More specifically, when the display 140 is displaying the electronic book as shown in FIG. 3, the user operates the touch part 161 to designate the first portion included in the electronic book being displayed on the display 140. A first portion P1 shown in FIG. 3, by way of example of the first portion, is part of text A2. The first-portion acquirer 111 thus receives the designation of the first portion that has been performed by the user, via the touch part 161.

As a method of designating the first portion, the user may touch a portion within the electronic book being displayed on the display 140 so as to indicate that the user desires to designate the portion as the first portion. Furthermore, the user may designate the first portion by inputting a page number, a line, and/or the number of characters that the user desires to designate as the first portion. Furthermore, the user may designate, from the electronic book, a portion that is not being displayed on the display 140, as the first portion.

The first-notification transmitter 112 transmits, to another electronic book terminal 100, a first notification that designates the received first portion.

More specifically, the first-notification transmitter 112 transmits the first notification via the communicator 150 to the other electronic book terminal 100 that is connected to the same wireless LAN access point 300.

The first-notification receiver 113 receives via the communicator 150 the first notification transmitted from the other electronic book terminal 100.

The display controller 114 causes the display 140 to display the first portion designated by the first notification received by the first-notification receiver 113. Moreover, the display controller 114 also causes the display 140 to display a second portion designated by a second notification received by the second-notification receiver 117.

More specifically, if the first portion or the second portion is designated as a page number of the electronic book, the display controller 114 causes the display 140 to display data regarding the page number. Furthermore, if the first portion or the second portion is designated as a specific area of a specific page of the electronic book, the display controller 114 causes the display 140 to display the specific page. Furthermore, the display controller 114 causes the display 140 to display the first portion or the second portion such that the first portion or the second portion is highlighted as if with a marker, with an underline, boldface and/or a larger font.

Upon the first-notification receiver 113 receiving the first notification, the second-portion acquirer 115 receives a designation of the second portion included in the electronic book from the user. The second portion is designated using a method similar to the above-described method of designating the first portion. Note that the second portion may be the same portion as the first portion or may be a different portion therefrom.

The second-notification transmitter 116 transmits the second notification that designates the second portion, to the electronic book terminal 100 that has transmitted the first notification received by the first-notification receiver 113.

The second-notification receiver 117 receives the second notification from the other electronic book terminal 100.

The operation controller 118 ignores any electronic-book viewing operation attempted by the user, after the first-notification transmitter 112 transmits the first notification and until the second-notification receiver 117 receives the second notification.

Operations of the electronic book 100 according to the present embodiment are now explained.

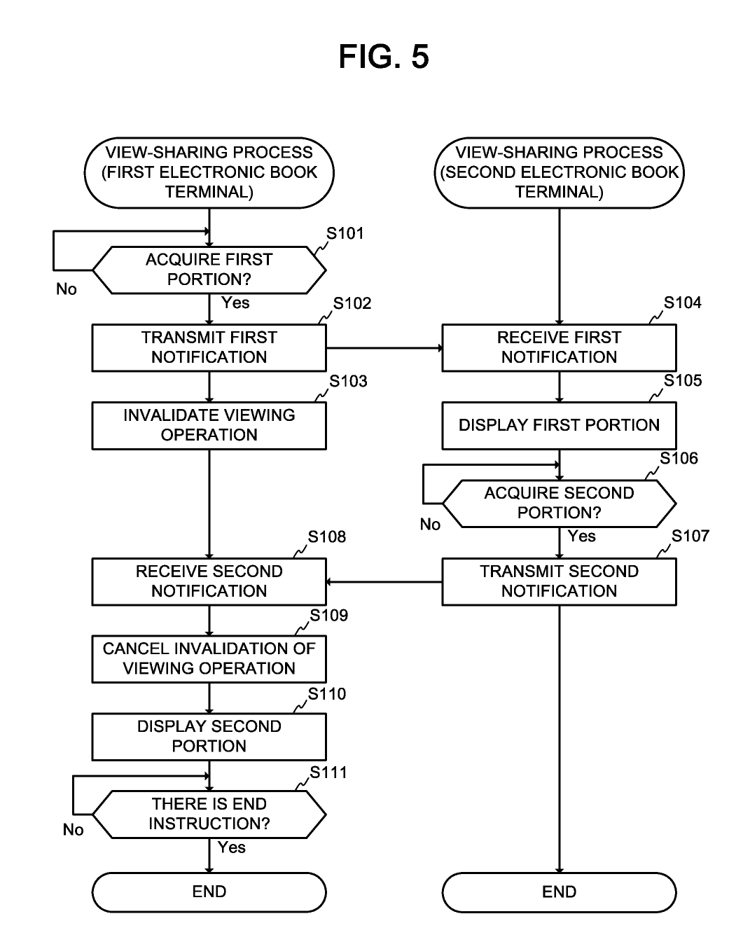

A view-sharing process, executed by the controller 110 of the electronic book terminal 100, is now explained. FIG. 5 shows an example of a flowchart of the view-sharing process. The view-sharing process as shown in FIG. 5 is a flowchart where the first electronic book terminal 100a transmits the first notification to the second electronic book terminal 100b. The view-sharing process starts in response to, for example, an operation input entered by the first user via the operator 160 of the first electronic book terminal 100a to start the execution of the view-sharing process. Moreover, this process is executed by, for example, the CPU of the controller 110 reading a program stored in the ROM 120.

The first-portion acquirer 111 of the first electronic book terminal 100a determines whether an operation input that designates the first portion has been received from the first user via the operator 160 of the first electronic book terminal 100a (Step S101). The first-portion acquirer 111 is then in a wait state until receiving the operation input that designates the first portion from the first user.

If the first-portion acquirer 111 determines that the operation input that designates the first portion has been received from the first user (Step S101; Yes), the first-notification transmitter 112 of the first electronic book terminal 100a transmits, to the second electronic book terminal second electronic-book terminal 100b, the first notification that designates the received first portion (Step S102).

Then, the operation controller 118 of the first electronic book terminal 100a invalidates any electronic-book viewing operation attempted by the first user, which has been received by the operator 160 (Step S103).

The first-notification receiver 113 of the second electronic book terminal 100b receives the first notification from the first electronic book terminal 100a (Step S104).

The display controller 114 of the second electronic book terminal 100b displays, on the display 140 of the second electronic book terminal 100b, the first portion designated by the first notification received in Step S103 (Step S105).

The second-portion acquirer 115 of the second electronic book terminal 100b determines whether an operation input that designates the second portion has been received from the second user via the operator 160 of the second electronic book terminal 100b (Step S106). The second-portion acquirer 115 is then in a wait state until receiving the operation input that designates the second portion from the second user (Step S106; No).

If the second-portion acquirer 115 determines that the operation input that designates the second portion has been received from the second user (Step S106; Yes), the second-notification transmitter 116 of the second electronic book terminal 100b transmits, to the first electronic book terminal 100a, the second notification that designates the received second portion (Step S107).

The second-notification receiver 117 of the first electronic book terminal 100a receives the second notification from the second electronic book terminal 100b (Step S108).

The operation controller 118 of the first electronic book terminal 100a cancels the invalidation of any electronic-book viewing operation attempted by the first user (Step S109).

The display controller 114 of the first electronic book terminal 100a displays, on the display 140 of the first electronic book terminal 100a, the second portion designated by the second notification that was received in Step S108 (Step S110).

The display controller 114 of the first electronic book terminal 100a determines whether an operation input to give an end instruction for the view-sharing process has been received from the first user via the operator 160 of the first electronic book terminal 100a (Step S111). The display controller 114 is then in a wait state until receiving the operation input to give the end instruction from the first user (Step S111; No). If the display controller 114 determines that the operation input to give the end instruction has been received from the first user (Step S111; Yes), the display controller 114 ends the process.

As explained above, in the communication system 100 of the present embodiment, the first electronic book terminal 100a that has transmitted the first notification to the second electronic book terminal 100b ignores any electronic-book viewing operation attempted by the first user until the first electronic book terminal 100a receives the second notification from the second electronic book terminal 100b. In other words, the first user cannot perform any electronic-book viewing operation unless the second user performs, on the second electronic book terminal 100b, an operation for transmitting the second notification.

Hence, the communication system 100 of the present embodiment can prevent a nuisance caused by the first user, that is, an act of sending unsolicited information from the first user to the second user. Thus, moderated communication between the users can be facilitated.

An embodiment of the present disclosure is explained above, but the present disclosure is not limited to the present embodiment. Modifications of the present embodiment will be explained below. In the modifications below, components similar to those of the above-described embodiment are denoted by the same reference signs, and details thereof are not discussed.

### Modification 1

Modification 1 of the above-described embodiment is now explained. In the above-described embodiment, if the first electronic book terminal 100a receives the second notification from the second electronic book terminal 100b, the first electronic book terminal 100a permits any electronic-book viewing operation attempted by the first user. Furthermore, in the present modification, if the second notification has not been received by the end of a predetermined time period after the transmission of the first notification, the first electronic book terminal 100a permits any electronic-book viewing operation attempted by the first user, in exchange for a predetermined compensation received from the first user.

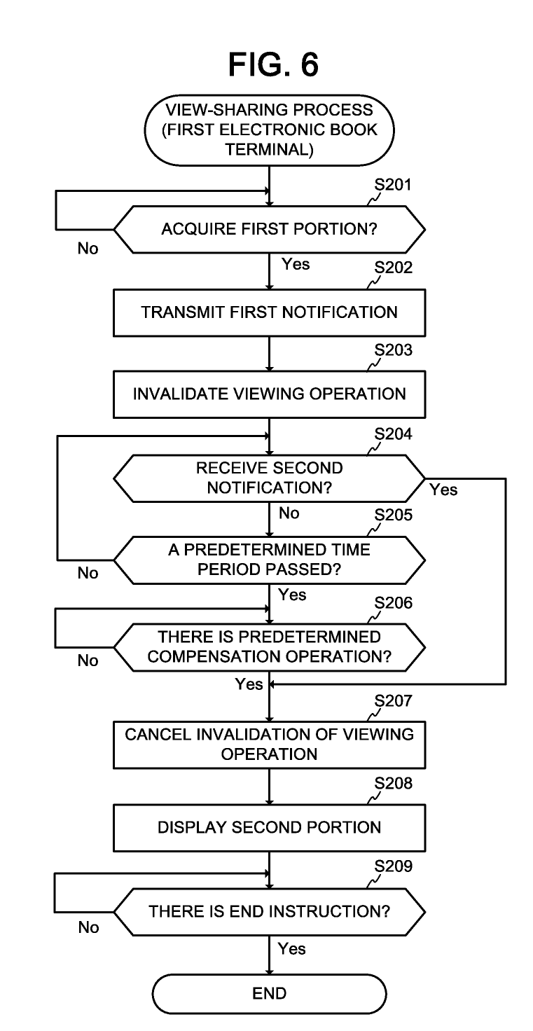

Operations of the first electronic book terminal 100a according to the present modification are now explained. FIG. 6 shows an example of a flowchart of a view-sharing process executed by the controller 110 of the first electronic book terminal 100a according to the present modification. The view-sharing process starts in response to, for example, an operation input entered by the first user via the operator 160 of the first electronic book terminal 100a to start the execution of the view-sharing process. Moreover, this process is executed by the CPU of the controller 110 reading a program stored in the ROM 120.

The controller 110 conducts, in Steps S201-S203, processing similar to that of Steps S101-S103 (see FIG. 5) of the embodiment.

Subsequently, the second-notification receiver 117 determines whether the second notification has been received from the second electronic book terminal 100b, which is a destination to which the first notification was transmitted in Step S203 (Step S204).

If the second-notification receiver 117 determines that the second notification has not been received (Step S204; No), the operation controller 118 determines whether the predetermined time period has passed after the first-notification transmitter 112 has transmitted the first notification (Step S205).

If the operation controller 118 determines that the predetermined time period has not passed after the first-notification transmitter 112 has transmitted the first notification (Step S205; No), the operation controller 118 returns the process to Step S204.

If the operation controller 118 determines that the predetermined time period has passed after the first-notification transmitter 112 has transmitted the first notification (Step S205; Yes), the operation controller 118 determines whether the operator 160 has received an operation input that represents the predetermined compensation from the first user (Step S206). The operation controller 118 is then in a wait state until determining that the operator 160 has received the operation input that represents the predetermined compensation from the first user (Step S206; No).

Here, the predetermined compensation means an action that the first user needs to take in exchange for changing the status of any electronic-book viewing operation attempted by the first user from invalid to valid. More specifically, the predetermined compensation is an action taken by the first user, such as viewing a predetermined advertisement displayed on the display 140, or paying a predetermined amount of money to a predetermined vendor.

Furthermore, the first electronic book terminal 100a may be set such that the first user is allowed to perform, only a predetermined number of times, an invalidation-cancelling operation to cause the first electronic book terminal 100a to permit any electronic-book viewing operation attempted by the first user. In this case, any electronic-book viewing operation attempted by the first user is permitted in response to the first user performing the invalidation-cancelling operation as the predetermined compensation.

Furthermore, the first electronic book terminal 100a may have points that are set thereto and are consumed each time the first user performs the invalidation-cancelling operation to cause the first electronic book terminal 100a to permit any electronic-book viewing operation attempted by the first user. In this case, any electronic-book viewing operation attempted by the first user is permitted in response to the first user consuming the points as the predetermined compensation.

If the second-notification receiver 117 determines that the second notification has not been received (Step S204; No), or if the operation controller 118 determines that the operation input that represents the predetermined compensation has been received from the first user (Step S206; Yes), the controller 110 conducts, in Steps S207-S209, processing similar to that of Steps S109-S111 (see FIG. 5) of the embodiment.

As explained above, in the communication system 100 of the present modification, if the second notification has not been received by the end of the predetermined time period, the first electronic book terminal 100a permits any electronic-book viewing operation attempted by the first user, in exchange for the predetermined compensation from the first user.

Hence, the communication system 100 of the present embodiment can prevent the nuisance caused by the first user, that is, the act of sending unsolicited information from the first user to the second user, without significantly impairing usability for the first user's utilization of the electronic book.

### Modification 2

Modification 2 of the above-described embodiment is now explained. In the present modification, the first electronic book terminal 100a transmits the first notifications to a plurality of second electronic book terminals 100b, and permits, if the number of received second notifications meets a predetermined condition, any electronic-book viewing operation attempted by the first user.

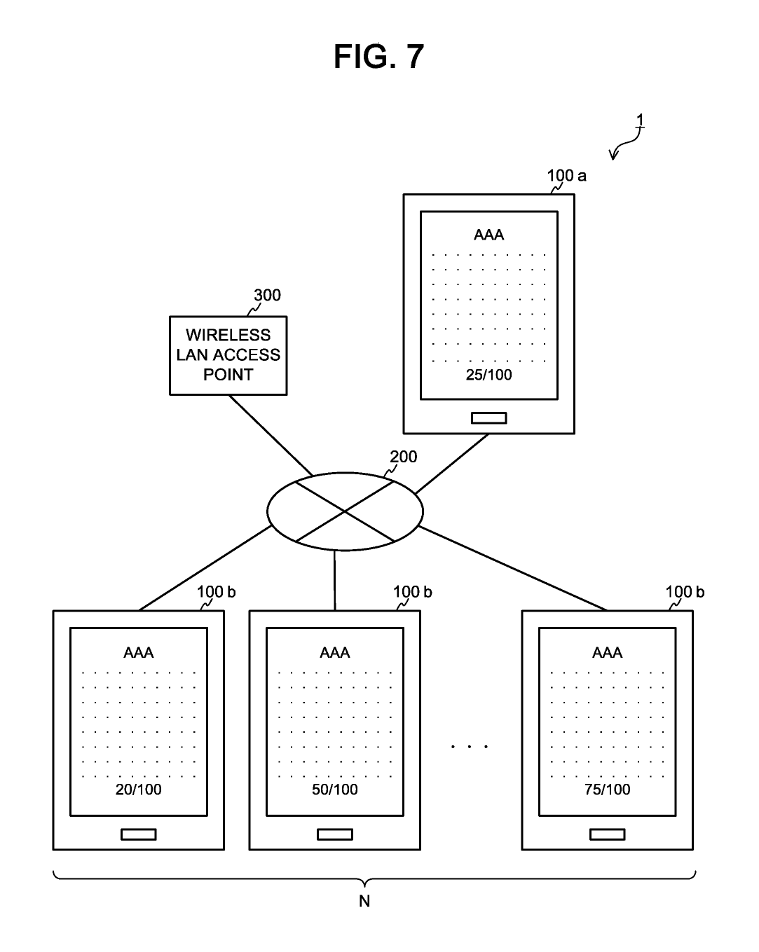

FIG. 7 shows a configuration of a communication system 1 according to the present modification. As shown in FIG. 7, the communication system 1 comprises a first electronic book terminal 100a and N number of second electronic book terminals 100b. Similar to the above-described embodiment, the first electronic book terminal 100a and N number of second electronic book terminals 100b have functions to connect to the network 200 wirelessly and communicate with each other via the wireless LAN access point 300 that relays the communication therebetween.

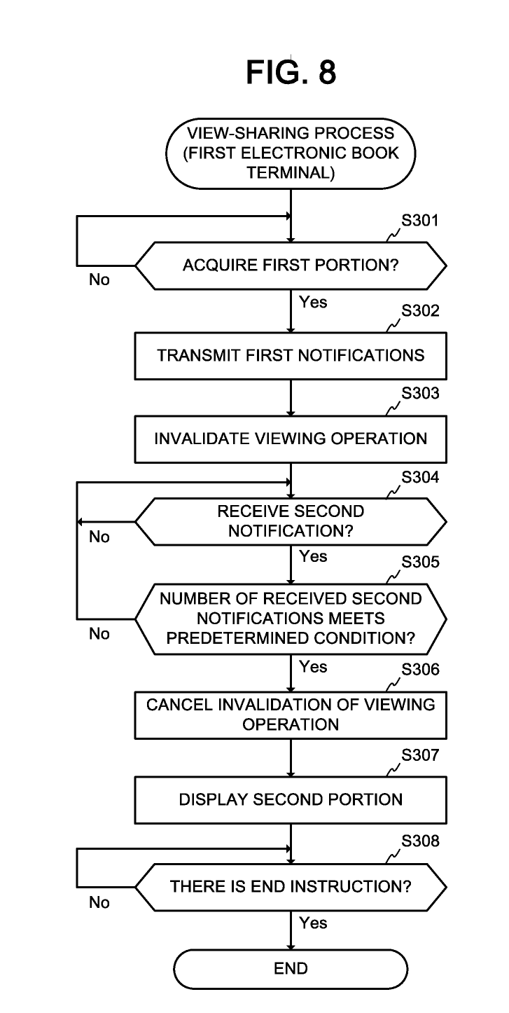

Operations of the first electronic book terminal 100a according to the present modification are now explained. FIG. 8 is an example of a flowchart of a view-sharing process executed by the controller 110 of the first electronic book terminal 100a according to the present modification. The view-sharing process starts in response to, for example, an operation input entered by the first user via the operator 160 of the first electronic book terminal 100a to start the execution of the view-sharing process. Moreover, this process is executed by, for example, the CPU of the controller 110 reading a program stored in the ROM 120.

The controller 110 conducts, in Steps S301-S303, processing similar to that of Steps S101-S103 (see FIG. 5) of the embodiment.

The second-notification receiver 117 then determines whether second notifications have been received from the second electronic book terminals 100b, which are destinations to which the first notification was transmitted in Step S303 (Step S304). The second-notification receiver 117 is then in a wait state until receiving second notifications (Step S304; No).

If the second-notification receiver 117 determines that the second notifications have been received (Step S304; Yes), the operation controller 118 determines whether the number of the received second notifications meets the predetermined condition (Step S305).

More specifically, the operation controller 118 sets a counter n for counting the second notifications, to the RAM 130. The operation controller 118 then increments the counter n each time the second notification is received. Then, the operation controller 118 determines, in Step S305, whether the value of the counter n meets the predetermined condition.

Here, the predetermined condition is, for example, a condition to the effect that the number of the second notifications, that is, the value of the counter n, or a ratio of the number of the second notifications with respect to N, the number of the second electronic book terminals 100b, has exceeded a predetermined threshold.

If the operation controller 118 determines that the number of the received second notifications meets the predetermined condition (Step S305; Yes), the controller 110 conducts, in Steps S306-S308, processing similar to that of Steps S109-S111 (see FIG. 5) of the embodiment.

As explained above, in the communication system 100 of the present modification, the first electronic book terminal 100a transmits the first notifications to a plurality of second electronic book terminals 100b, and permits, if the number of the received second notifications meets the predetermined condition, any electronic-book viewing operation attempted by the first user.

Hence, even when the first electronic book terminal 100a transmits the first notifications to a plurality of second electronic book terminals 100b, the communication system 100 of the present embodiment can prevent the nuisance caused by the first user, that is, the act of sending unsolicited information from the first user to the second users, without significantly impairing usability for the first user's utilization of the electronic book.

### Modification 3

Modification 3 of the above-described embodiment is now explained. In the present modification, the second electronic book terminal 100b allows the second user to view the first portion designated by the received first notification as well as a history of a past first notification transmitted in the past by the first electronic book terminal 100a that has transmitted the received first notification.

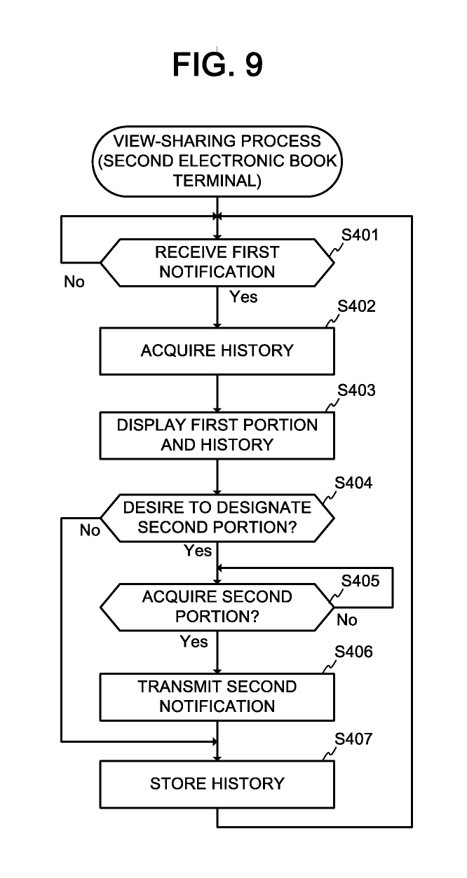

Operations of the second electronic book terminal 100b according to the present modification are now explained. FIG. 9 is an example of a flowchart of a view-sharing process executed by the controller 110 of the second electronic book terminal 100b according to the present modification. The view-sharing process starts in response to, for example, an operation input entered by the second user via the operator 160 of the second electronic book terminal 100b to start the execution of the view-sharing process. Furthermore, this process is executed by, for example, the CPU of the controller 110 reading a program stored in the ROM 120.

First, the first-notification receiver 113 of the second electronic book terminal 100b determines whether the first notification has been received from the first electronic book terminal 100a (Step S401). The first-notification receiver 113 is then in a wait state until determining that the first notification has been received from the first electronic book terminal 100a (Step S401; No).

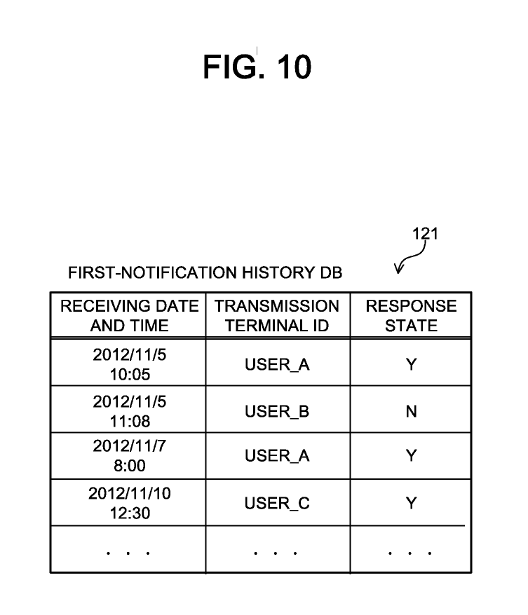

If the first-notification receiver 113 determines that the first notification has been received (Step S401; Yes), the first-notification receiver 113 acquires, from a first-notification history DB 121 (see FIG. 10) stored in the ROM 120, the history of the past first notification transmitted in the past by the first electronic book terminal 100a that has transmitted the received first notification (Step S402).

Data stored in the first-notification history DB 121 is now explained. FIG. 10 shows an example of the data stored in the first-notification history DB 121. As shown in FIG. 10, in the first-notification history DB 121, data representing a receiving date and time, a transmission terminal ID and a response state are stored. The receiving date and time is a date and time when the first notification is received. The transmitting terminal ID is identification data of the first electronic book terminal that has transmitted the first notification. The response state represents whether the second user has responded to the received first notification, that is, whether the second electronic book terminal 100b has transmitted the second notification to the first electronic book terminal 100a that has transmitted the first notification. If the second electronic book terminal 100b has transmitted the second notification to the first electronic book terminal 100a that has transmitted the first notification, “Y” is stored as the response state. Furthermore, if the second electronic book terminal 100b has not transmitted the second notification to the first electronic book terminal 100a that has transmitted the first notification, “N” is stored as the response state.

Specific operations of the first-notification receiver 113 in Step S402 are now explained. When receiving the first notification, the first-notification receiver 113 specifies the identification data of the first electronic book terminal 100a that has transmitted the first notification. Then, the first-notification receiver 113 searches the first-notification history DB 121 using the specified identification data as a key, and acquires, as history data, the number of first notifications transmitted in the past by the first electronic book terminal 100a that has transmitted the first notification and the number of times the second user responded to the first notifications.

Returning to FIG. 9, the display controller 114 displays, on the display 140, the first portion designated by the first notification received in Step S401 and the history data acquired in Step S402 (Step S403).

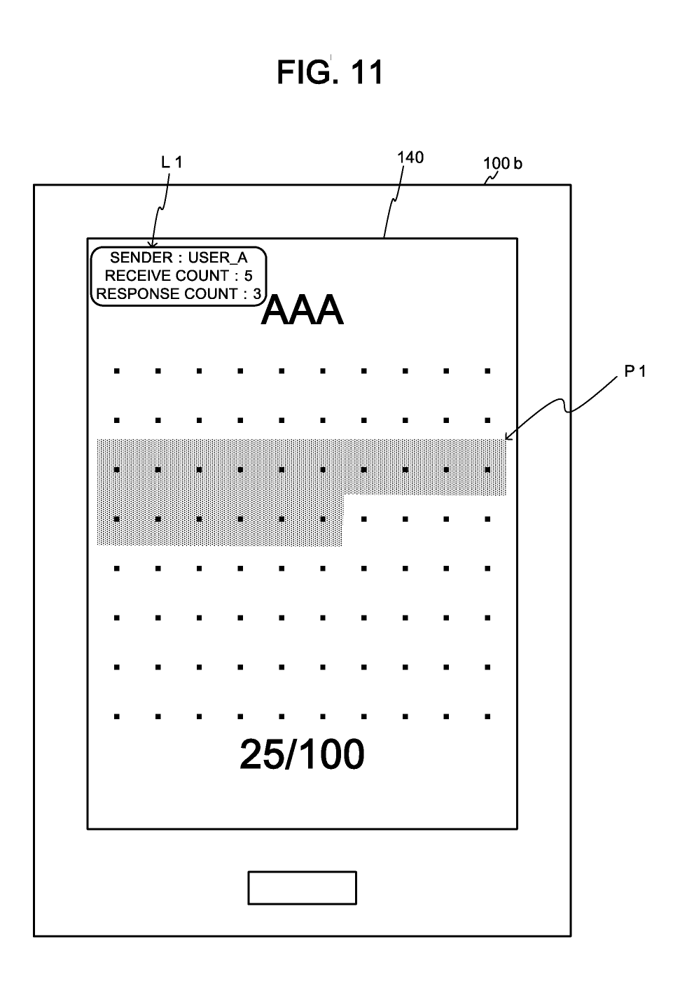

FIG. 11 shows an example of the first portion and the history data displayed on the display 140. As shown in FIG. 11, the display controller 114 displays the first portion P1 in a manner similar to that of the above-described embodiment, and displays the history data L1 acquired in Step S403. The history data L1 includes information that represents a sender, a receive count, and a response count. The sender is the identification data of the first electronic book terminal 100a that transmitted the first notification received in Step S401. The receive count is the number of first notifications received in the past from the first electronic book terminal 100a identified by the sender. The receive count is, among the past first notifications, the number of past first notifications to which the second user responded.

Note that the history data displayed on the display 140 is not limited to the example as shown in FIG. 11. For example, the first-notification receiver 113 may refer to the first-notification history DB 121 to acquire, as the data to be displayed on the display 140, data that indicates what ordinal position the first notification received in Step S401 occupies in the series of the first notifications received from the electronic book terminal 100a that has transmitted the first notification received in Step S401, as well as data that indicates the receiving dates and times when the first notifications were received from the electronic book terminal 100a that has transmitted the first notification received in Step 401.

Returning to FIG. 9, the second-portion acquirer 115 determines whether an operation input to the effect that the second user desires to designate the second portion has been received from the second user via the operator 160 (Step S404). If the second-portion acquirer 115 determines that the operation input to the effect that the second user desires to designate the second portion has not been received from the second user (Step S404; No), the process proceeds to Step S407.

If the second-portion acquirer 115 determines that the operation input to the effect that the second user desires to designate the second portion has been received from the second user via the operator 160 (Step S404; Yes), the second-portion acquirer 115 determines whether the designation of the second portion has been received from the second user via the operator 160 (Step S405). The second-portion acquirer 115 is then in a wait state until determining that the designation of the second portion has been received from the second user (Step S405; No).

If the second-portion acquirer 115 determines that the designation of the second portion has been received from the second user via the operator 160 (Step S405; Yes), the second-notification transmitter 116 transmits, to the first electronic book terminal 100a, the second notification that designates the received second portion (Step S406).

Thereafter, the second-notification transmitter 116 records, in the first-notification history DB 121, the history of the past first notification received in Step S401 (Step S407).

Then, the controller 110 returns the process to Step S401 and repeats the processing of Steps S401-S407 until, for example, an operation input to give an end instruction for the view-sharing process has been received from the second user.

As explained above, in the communication system 100 of the present modification, the second electronic book terminal 100b allows the second user to view the first portion designated by the received first notification and the history of the past first notification transmitted in the past by the electronic book terminal 100a that has transmitted the first notification.

Hence, the communication system 100 of the present embodiment enables the second user to determine, based on the history of the first notification, whether to transmit the second notification to the first electronic book terminal 100a that has transmitted the first notification.

### Modification 4

Modification 4 of the above-described embodiment is now explained. In the present modification, if the first portion designated by the received first notification is a portion that has yet to be read by the second user, the second electronic book terminal 100b ignores the fact that the second electronic book terminal 100b has received the first notification.

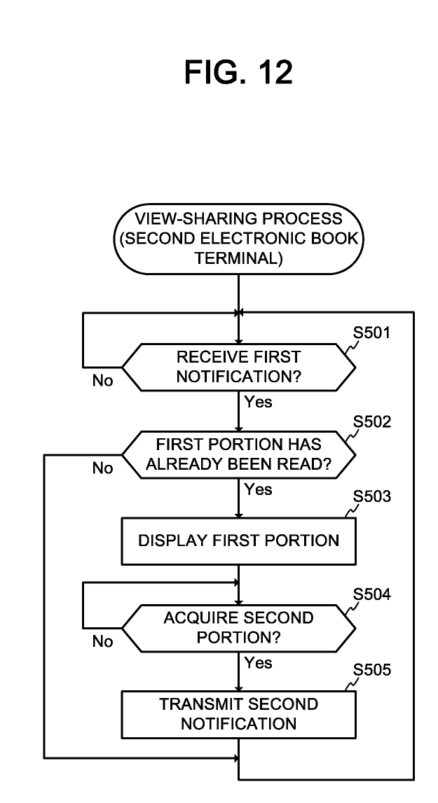

Operation of the second electronic book terminal 100b according to the present modification is now explained. FIG. 12 is an example of a flowchart of a view-sharing process executed by the controller 110 of the second electronic book terminal 100b according to the present modification. The view-sharing process starts in response to, for example, an operation input entered by the second user via the operator 160 of the second electronic book terminal 100a to start the execution of the view-sharing process. Furthermore, this process is executed by, for example, the CPU of the controller 110 reading a program stored in the ROM 120.

First, the first-notification receiver 113 of the second electronic book terminal 100b determines whether the first notification has been received from the first electronic book terminal 100a (Step S501). The first-notification receiver 113 waits until determining that the first notification has been received from the first electronic book terminal 100a (Step S501; No).

If the first-notification receiver 113 determines that the first notification has been received (Step S501; Yes), the first-notification receiver 113 determines whether the first portion designated by the first notification is a portion that has already been read by the second user (Step S502).

More specifically, in the ROM 120, data representing up to which portion of the electronic book the second user has read, for example, reading history data containing data that represents pages of the electronic book that have already been displayed on the display 140, is stored for each electronic-book stored in the ROM 120.

Then, the first-notification receiver 113 refers to the reading history data and determines whether the electronic book relating to the first portion designated by the first notification is stored in the ROM 120. If the first-notification receiver 113 determines that the electronic book relating to the first portion designated by the first notification is not stored in the ROM 120, the first-notification receiver 113 determines that the first portion designated by the first notification is the portion that has yet to be read by the second user. Furthermore, if the first-notification receiver 113 determines that the electronic book relating to the first portion designated by the first notification is stored in the ROM 120, the first-notification receiver 113 refers to the reading history data to determine whether the first portion designated by the first notification is the portion that has already been read by the second user.

If the first-notification receiver 113 determines that the first portion designated by the first notification is the portion that has already been read by the second user (Step S502; Yes), the controller 110 conducts, in Steps S503-S505, processing similar to that of Steps S105-S107 (see FIG. 5) of the embodiment.

If the first-notification receiver 113 determines that the first portion designated by the first notification is the portion that has yet to be read by the second user (Step S502; No), the first-notification receiver 113 returns the process to S201.

In other words, if the first portion designated by the first notification is the portion that has yet to be read by the second user, the second electronic book terminal 100b does not execute processing subsequent to Step S503, so that the results are similar to those obtained in the case where the first notification is not received in Step S501.

As described above, in the communication system 100 of the present modification, if the first portion designated by the received first notification is the portion that has yet to be read by the second user, the second electronic book terminal 100b ignores the fact that the first notification has been received.

Hence, the communication system 100 of the present embodiment can prevent the first portion that has yet to be read by the second user from being forcibly displayed on the display 140.

The above-described embodiment and Modifications 1 to 4 may be modified as below.

For example, although the above-described embodiment and Modifications 1 to 4 explain an example where the first electronic book terminal 100a and the second electronic book terminal 100b communicate with each other via the wireless LAN access point 300, any method may be employed for communication between the electronic book terminal 100a and the second electronic book terminal 100b. For example, the first electronic book terminal 100a and the second electronic book terminal 100b may communicate with each other directly, without the wireless LAN access point 300 that relays the communication therebetween.

Furthermore, in the above-described embodiment and Modifications 1 to 4, the second electronic book terminal 100b transmits the second notification that designates the second portion to the first electronic book terminal 100a. However, information represented by the second notification is not limited to this. For example, the second notification may be transmitted to give an instruction to cancel invalidation of any electronic-book viewing operation attempted by the first user.

In this case as well, similar to the above-described embodiment and

Modifications 1 to 4, the first user cannot perform any electronic-book viewing operation unless the second user performs an operation for transmitting the second notification from the second electronic book terminal 100b.

Hence, the communication system 100 of the present embodiment can prevent the nuisance caused by the first user, that is, the act of sending unsolicited information from the first user to the second user. Thus, moderated communication between the users can be facilitated.

Note that, in the above-described embodiment, the programs executed by the electronic book terminal 100 may be saved and distributed on a non-transitory computer-readable recording medium such as a flexible disc, compact disk read-only memory (CD-ROM), digital versatile disk (DVD), and magneto-optical disk (MO). Then, the programs may be installed on an information processing device such as a personal computer to configure a system executing the above-described process.

Alternatively, the programs may be saved in a disk device of a predetermined server unit on a communication network such as the Internet. Moreover, for example, the programs may be configured so as to be superimposed on carrier waves and to be downloaded.

Furthermore, when the above-described functions are realized by an operating system (OS) in part or by cooperation of an OS and applications, only the programs of the OS other than those realizing the functions may be saved and distributed on a non-transitory recording medium, or may be downloaded.

The foregoing describes an example embodiment for explanatory purposes. Although the foregoing discussion has presented specific embodiment, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for communication between a plurality of electronic book terminals on which an identical electronic book is viewable.

### REFERENCE SIGNS LIST

1 Communication system
100 Electronic book terminal
100a First electronic book terminal
100b Second electronic book terminal
110 Controller
111 First-portion acquirer
112 First-notification transmitter
113 First-notification receiver
114 Display controller
115 Second-portion acquirer
116 Second-notification transmitter
117 Second-notification receiver
118 Operation controller
120 ROM
121 First-notification history DB
130 RAM
140 Display
150 Communicator
160 Operator
161 Touch part
162 Button
170 Bus
200 Network
300 Wireless LAN access point

1. A communication system comprising a first electronic book terminal and at least one second electronic book terminal, the first electronic book terminal enabling a first user to view an electronic book based on an operation by the first user, the at least one second electronic book terminal enabling a second user to view the electronic book based on an operation by the second user, wherein
(a) the first electronic book terminal receives a designation of a first portion included in the electronic book from the first user, and transmits, to the at least one second electronic book terminal, a first notification that designates the received first portion,
(b) the at least one second electronic book terminal receives the first notification transmitted from the first electronic book terminal, allows the second user to view the first portion designated by the received first notification, receives a designation of a second portion included in the electronic book from the second user who has viewed the first portion upon the receiving of the first notification by the at least one second electronic book terminal, and transmits, to the first electronic book terminal, a second notification that designates the second portion,
(c) the first electronic book terminal receives the second notification transmitted from the at least one second electronic book terminal, and allows the first user to view the second portion designated by the received second notification, and
(d) the first electronic book terminal ignores, after transmitting the first notification and until receiving the second notification, any operation attempted by the first user for viewing the electronic book.

2. A communication system comprising a first electronic book terminal and at least one second electronic book terminal, the first electronic book terminal enabling a first user to view an electronic book based on an operation by the first user, the at least one second electronic book terminal enabling a second user to view the electronic book based on an operation by the second user, wherein
(a) the first electronic book terminal receives a designation of a first portion included in the electronic book from the first user, and transmits, to the at least one second electronic book terminal, a first notification that designates the received first portion,
(b) the at least one second electronic book terminal receives the first notification transmitted from the first electronic book terminal, allows the second user to view the first portion designated by the received first notification, receives a designation of a second portion included in the electronic book from the second user, and transmits, to the first electronic book terminal, a second notification that designates the second portion,
(c) the first electronic book terminal receives the second notification transmitted from the at least one second electronic book terminal, and allows the first user to view the second portion designated by the received second notification,
(d) the first electronic book terminal ignores, after transmitting the first notification and until receiving the second notification, any operation attempted by the first user for viewing the electronic book, and
(e) if the first portion designated by the received first notification is a portion that has yet to be read by the second user, the at least one second electronic book terminal ignores a fact that the first notification has been received.

3. The communication system according to claim 1, wherein
the at least one second electronic book terminal comprises a plurality of second electronic book terminals, and
the first electronic book terminal transmits the first notification to the plurality of second electronic book terminals, and permits, if the number of the received second notifications meets a predetermined condition, the operation attempted by the first user for viewing the electronic book.

4. The communication system according to claim 1, wherein
the at least one second electronic book terminal stores a history of the received first notification in a first-notification history storage,
when receiving the first notification transmitted from the first electronic book terminal, the at least one second electronic book terminal acquires a history of a past first notification from the first-notification history storage, the past first notification being transmitted in the past by the first electronic book terminal that has transmitted the received first notification, and
the at least one second electronic book terminal allows the second user to view the first portion designated by the received first notification and the acquired history of the past first notification.

5. The communication system according to claim 1, wherein, if the second notification has not been received by an end of a predetermined time period after the transmission of the first notification, the first electronic book terminal permits the operation attempted by the first user for viewing the electronic book, in exchange for a predetermined compensation from the first user.

6. An electronic book terminal enabling a user to view an electronic book based on an operation by the user, the electronic book terminal comprising:
a first-portion acquirer that receives a designation of a first portion included in the electronic book from the user;
a first-notification transmitter that transmits a first notification to at least one other electronic book terminal on which the electronic book is viewable, the first notification designating the received first portion;
a second-notification receiver that receives a second notification transmitted from the other electronic book terminal, when the other electronic book terminal receives the first notification, allows another user to view the first portion designated by the received first notification, receives a designation of a second portion included in the electronic book from the other user who has viewed the first portion upon the receiving of the first notification by the at least one other electronic book terminal, and transmits the second notification that designates the second portion;
a display controller that allows the first user to view the second portion designated by the received second notification; and
an operation controller that ignores, after the first notification is transmitted and until the second notification is received, any operation attempted by the user for viewing the electronic book.

7. A communication method executed by a first electronic book terminal and at least one second electronic book terminal,
the first electronic book terminal enabling a first user to view an electronic book based on an operation by the first user, and including a first-portion acquirer, a first-notification transmitter, a second-notification receiver, a second-display controller, and an operation controller,
the at least one second electronic book terminal enabling a second user to view the electronic book based on an operation by the second user, and including a first-notification receiver, a first-display controller, a second-portion acquirer, and a second-notification transmitter,
the communication method comprising:
(a) for the first electronic book terminal,
a first portion acquiring step in which the first-portion acquirer receives a designation of a first portion included in the electronic book from the first user, and
a first notification transmitting step in which the first-notification transmitter transmits, to the at least one second electronic book terminal, a first notification that designates the received first portion,
(b) for the at least one second electronic book terminal,
a first notification receiving step in which the first-notification receiver receives the first notification transmitted from the first electronic book terminal,
a first-display controlling step in which the first-display controller allows the second user to view the first portion designated by the received first notification,
a second portion acquiring step in which the second-portion acquirer receives a designation of a second portion included in the electronic book from the second user who has viewed the first portion upon the receiving of the first notification by the at least one second electronic book terminal, and
a second notification transmitting step in which the second-notification transmitter transmits, to the first electronic book terminal, a second notification that designates the second portion,
(c) for the first electronic book terminal,
a second notification receiving step in which the second notification receiver receives the second notification transmitted from the at least one second electronic book terminal, and
a second-display controlling step in which the second-display controller allows the first user to view the second portion designated by the received second notification, and
(d) for the first electronic book terminal,
an operation controlling step in which the operation controller ignores any operation attempted by the first user for viewing the electronic book after the first notification is transmitted until the second notification is received.

8. (canceled)

9. (canceled)

10. The communication system according to claim 2, wherein
the at least one second electronic book terminal comprises a plurality of second electronic book terminals, and
the first electronic book terminal transmits the first notification to the plurality of the second electronic book terminals, and permits, if the number of the received second notifications meets a predetermined condition, the operation attempted by the first user for viewing the electronic book.

11. The communication system according to claim 2, wherein
the at least one second electronic book terminal stores a history of the received first notification in a first-notification history storage,
when receiving the first notification transmitted from the first electronic book terminal, the at least one second electronic book terminal acquires a history of a past first notification from the first-notification history storage, the past first notification being transmitted in the past by the first electronic book terminal that has transmitted the received first notification, and
the at least one second electronic book terminal allows the second user to view the first portion designated by the received first notification and the acquired history of the past first notification.

12. The communication system according to claim 2, wherein, if the second notification has not been received by an end of a predetermined time period after the transmission of the first notification, the first electronic book terminal permits the operation attempted by the first user for viewing the electronic book, in exchange for a predetermined compensation from the first user.

13. The electronic book terminal according to claim 6, wherein
the at least one other electronic book terminal comprises a plurality of other electronic book terminals,
the first-notification transmitter transmits the first notification to the plurality of the other electronic book terminals, and
the operation controller permits, if the number of the received second notifications meets a predetermined condition, the operation attempted by the first user for viewing the electronic book.

14. The electronic book terminal according to claim 6, wherein, if the second notification has not been received by an end of a predetermined time period after the transmission of the first notification, the operation controller permits the operation attempted by the first user for viewing the electronic book, in exchange for a predetermined compensation from the first user.

15. The communication method according to claim 7, wherein
the at least one second electronic book terminal comprises a plurality of second electronic book terminals, and
the first-notification transmitter transmits the first notification to the plurality of second electronic book terminals, and
the operation controller permits, if the number of the received second notifications meets a predetermined condition, the operation attempted by the first user for viewing the electronic book.

16. The communication method according to claim 7, wherein
the second-notification transmitter stores a history of the received first notification in a first-notification history storage,
when receiving the first notification transmitted from the first electronic book terminal, the first-notification receiver acquires a history of a past first notification from the first-notification history storage, the past first notification being transmitted in the past by the first electronic book terminal that has transmitted the received first notification, and
the first-display controller allows the second user to view the first portion designated by the received first notification and the acquired history of the past first notification.

17. The communication method according to claim 7, wherein, if the second notification has not been received by an end of a predetermined time period after the transmission of the first notification, the operation controller permits the operation attempted by the first user for viewing the electronic book, in exchange for a predetermined compensation from the first user.
